(19) United States
(12) Patent Application Publication
(10) Pub. No.: US 2020/0349558 A1
(43) Pub. Date: Nov. 5, 2020

(54) METHOD FOR PERFORMING PAYMENT TRANSACTIONS

(71) Applicant: Oleg SEREBRENNIKOV, Moscow (RU)

(72) Inventor: Oleg SEREBRENNIKOV, Moscow (RU)

(21) Appl. No.: 16/963,799

(22) PCT Filed: Jan. 25, 2019
(86) PCT No.: PCT/RU2019/000044

§ 371 Date: Jul. 21, 2020

(30) Foreign Application Priority Data
Jan. 22, 2018 (RU) 2018102282

(51) Int. Cl. G06Q 20/36; G06Q 20/06; G06Q 40/02

(52) U.S. Cl. CPC G06Q 20/3674; G06Q 40/02; G06Q 20/0655; G06Q 20/3678

(57) ABSTRACT

The present invention relates to the field of information technology, the field of issuing and circulating electronic money and cryptocurrency, and the field of payment system technology and making payments. The present invention allows for creating a payment system that uses an Internet connection addressing system instead of BIN routing, and that is compatible with payment tokenization technology and making payments using payment cards and cryptocurrency, which in turn allows for decreasing the cost of making payments by means of using free Internet routing when making said payments, and also allows for providing buyers with the possibility of paying for purchases in cryptocurrency and of exchanging cryptocurrency for fiat money and vice versa using payment card technology. The technical result is achieved by replacing BIN routing of a payment card network by DNS routing of the Internet, as well as by adding an additional DNS token and cryptocurrency wallet address token to a database of a token service provider, and using said tokens to make payments.

The present invention relates to the field of computer technology and information technology, namely, to the field of creating and using databases and electronic document management systems, routing payments, routing network connections, making payments, functioning of payment systems and communication networks, as well as to the field of ensuring security in making payments. The purpose of the invention is to create a payment bridge that ensures the routing of payments between different payment systems (payment schemes):
1. card payment scheme EMV Co (Europay, MasterCard, VISA);
2. a payment scheme based on the Internet connection routing system and represented by patents U.S. Pat. Nos. 8,868,467, 9,043,246, RU2464637 and RU2509360 (hereinafter referred to as “Serebrennikov's invention”, “Serebrennikov's method” or “Serebrennikov's payment system”, “Serebrennikov's routing identifier”);
3. cryptocurrency payment schemes
4. other well-known payment systems
   for making payments in the consumer market and other payments.

The technical result of creating a payment bridge and switching to the network level of addressing payments is achieved by 1) recording the Serebrennikov's routing identifier, as well as routing identifiers of user accounts in other payment systems in the routing table of the Token Service Provider of the EMVCo payment scheme as PAN tokens and 2) obtaining access by users to the services of a Token Service Provider (TSP) using the Serebrennikov method. These measures allow achieving the following beneficial result:
1. using the Serebrennikov method allows to switch from the Application layer (Application layer in the OSI network model) used when routing connections in the EMVCo network to the Transport and Network layers (transport layer and network layer) of routing the Internet, SS7 or another public network
2. placing routing identifiers in a single TSP routing table allows
   a. reduce the time for making payments between accounts of different payment schemes, reduce the amount of stored data,
   b. Reduce storage maintenance costs by reducing the number of service facilities and using the Internet instead of private payment routing networks
   c. reduce system vulnerability during attacks by reducing the number of access protection objects

The payment system of card payments currently almost monopolistically owns the market for non-cash payments in the consumer market, and therefore the present invention proposes to choose the solution proposed by EMVCo as part of the payment tokenization approach as a basis for combining routing tables (https://www.emvco.com/emv-technologies/payment-tokenisation/). At the same time, the present invention proposes adding identifiers of various payment schemes as PAN tokens to the Token Service Provider (TSP) table of the EMVCo payment scheme. The technical result is to reduce the routing level from the application to the transport and network levels in the OSI model, as well as to use a single routing table for routing payments between different payment systems instead of several routing tables for each of the payment systems.

A useful economic effect of the present invention is to reduce the cost of designing and implementing a system of intersystem payments due to the full compatibility of the proposed solution with the technology of tokenization of card payments and, as a result, full compliance with the EMVCo specifications, including the PCI DSS and PA DSS family of standards, which allows ensuring data protection at the level of requirements of the payment card industry standards (PCI DSS—payment card industry data security standards).

### BRIEF SUMMARY OF THE INVENTION

Serebrennikov's invention proposes to use network identifiers as a surrogate for identifying a financial account, and making payments according to Serebrennikov's method involves providing the service of resolving the network account identifier to the network address of the Payment Service Provider and sending a network message to the Provider—a payment instruction containing at least the online account identifier of the payer or merchant and the amount of the transaction. The tokenization of payments proposed later by EMVCo, like Serebrennikov's method, involves the use of a surrogate for the payment card account identifier (primary account number—PAN), called a token. Although market participants can use different token formats, the EMVCo token format is similar to that of a payment card number and is a route address that encodes the BIN address of the Token Service Provider (TSP) and the buyer's account number in the TSP table. The TSP table contains customer records, each of which links the customer's token with the data of his payment card—with the PAN. Thus, the TSP table is a routing table, and the PAN lookup service by token is similar to the service of resolving network names into Internet network addresses (for example, DNS names into IP addresses) used in the framework of Serebrennikov's invention. In addition, the tokenization guidelines outlined in the document (https://www.pcisecuritystandards.org/documents/Tokenization_Guidelines_Info_Supplement.pdf, page 5) do not contain specific format requirements for payment card tokens, which allows the token to be formatted as a network account identifier. according to Serebrennikov's invention.

The above features of tokenization and Serebrennikov's method allow to place account identifiers of various payment schemes as PAN tokens of a card payment scheme in the EMVCo extended Token Service Provider table, and use the expanded TSP table itself as a payment routing table, “resolving” (name resolution—https://en.wikipedia.org/wiki/Name_resolution) account identifier of a specific payment scheme to one or more account identifiers of other payment schemes and vice versa. For example, to resolve the network identifier (Serebrennikov's method) into the identifier of the card payment scheme—PAN and into the identifier of the cryptocurrency wallet for carrying out transactions between the named PANs and the cryptocurrency wallet or vice versa. Thus, the placement of routing identifiers of various payment systems in the TSP table allows the Token Service Provider table to be used as a routing table between PAN and other customer accounts. The difference from the Serebrennikov method in this case is that the network address of the user is mapped to the network address of the Token Service Provider, the table of which provides routing of payments between the user's financial accounts in various payment schemes, for which the TSP creates and uses a routing table in which accounts of various payment schemes are contained in the user's record where they are mapped to each other, and the TSP technology allows providing the service of resolving account identifiers of one payment scheme into identifiers of other payment schemes, which, with technological support for making payments of the corresponding payment schemes, allows payments between different payment schemes, whose identifiers accounts are presented as PAN tokens in the Token Service Provider table.

### PROBLEM

Currently, VISA/Mastercard card payments dominate the consumer market for non-cash payments for purchased goods and services, they offer a convenient and fast way to pay for purchased goods and services.

Despite the fact that cryptocurrencies have also become widespread in recent years, the speed of making payments using them for a long time was significantly lower than in the payment system of card payments. So in the Bitcoin network, it takes minutes or even hours to complete a transaction, which makes it unsuitable for paying for purchases in the consumer market.

Another disadvantage of cryptocurrencies is that access to payments in cryptocurrencies is not convenient and requires special knowledge and skills, which makes it much more difficult for most buyers than using payment cards. The use of payment card technology for making payments in cryptocurrency is faced with various difficulties, one of which is the reluctance of card payment systems to give way to cryptocurrencies in the payment market.

While cryptocurrencies with a payment speed comparable to or even exceeding the speed of card payments have already appeared, the technology of crypto payments is not compatible with technologies used at the point of sale, and the convenience and intuitive clarity of their use still does not meet the expectations of buyers and sellers of the consumer market. This slows down the penetration of cryptocurrencies into the consumer payments market. The use of technology for conducting card payments for payments in cryptocurrency would allow cryptocurrency to penetrate the payment market for goods and services purchased in the consumer market, and the present invention solves this problem by using payment card tokenization technology for payments in cryptocurrency.

However, as noted, the use of tokenization technology for making payments in cryptocurrency may face opposition from companies such as VISA and Mastercard and their reluctance to interact with providers of payments in cryptocurrency, which, in turn, may lead to difficulties or even the impossibility of introducing crypto payments in consumer market. The present invention makes it possible to reduce the impact of such opposition or even avoid it by using a payment routing scheme according to Serebrennikov's invention, which is an alternative to the payment routing BIN used for card payments by VISA/Mastercard and others.

### THE ESSENCE OF THE INVENTION

Payment systems are concerned about cases of unauthorized access by cybercriminals to plastic card data (Primary Account Number or PAN). In this regard, the issues of secure use of plastic card numbers have become the focus of attention of payment systems, and one of the ways to protect data from leakage is the PAN tokenization method. PAN tokenization refers to the process of replacing a disclosure-sensitive data item—PAN—with its meaningless surrogate—a token that is of no value to potential attackers. De-tokenization refers to the reverse process of retrieving PAN when presenting a token. In the process of PAN tokenization, a token is generated for a user's known PAN, a mapping is established between the PAN and the corresponding token by creating a mapping table in the payment network where an entry is made for each user containing the PAN and the corresponding token. In the process of PAN de-tokenization, a token is received from the merchant, the token is searched in the lookup table and the user PAN corresponding to token is retrieved from the table. To provide tokenization and de-tokenization services, a Token Service Provider is created in the network. The TSP has a well-secured database for storing a table mapping a PAN<=>token pair for each user.

As the text on page 5 of the “Information Supplement: PCI DSS Tokenization Guidelines” (https://www.pcisecuritystandards.org/documents/Tokenization_Guidelines_Info_Supplement.pdf) tokenization guidelines suggests, the format and size of tokens created by third parties are not regulated by these recommendations and therefore can be anything. At the same time, in accordance with the “EMV Payment Tokenization Specification”, the EMV Co token format itself, like the PAN format, must be based on the use of BIN range (https://www.emvco.com/terms-of-use/?u=wp-content/uploads/documents/EMVCo-Payment-Tokenisation-Specification-Technical-Framework-v2.0.pdf). To identify issuers, EMV Co traditionally uses BIN (Bank Identification Number), which comply with ISO/IEC 7812/7816 standards. The list of BINs of bank identifiers is published in open sources (https://www.bindb.com/bin-list.html). In EMV Co networks, BIN identifiers are part of the payment card number to identify the card issuer—a financial institution (bank). BIN identifiers are also part of the EMVCo token (hereinafter “BIN token” or “BIN token”) to identify the issuer of the token—Token Service Provider. The use of BIN for routing connections to both the issuer and the TSP allows the use of the same routing rules for connections in EMVCo networks. When making a payment, the merchant to whom the BIN token is presented, using the BIN, easily finds the TSP that issued the named BIN token and turns to this TSP for de-tokenization in order to obtain the data of the card number (PAN) corresponding to the BIN token for subsequent payment using the PAN.

Card payment routing, based on the use of card numbers containing BIN identifiers, appeared in the days when there was no Internet, card payment companies included in EMVCo created their own payment networks, and therefore BIN routing was justified. With the emergence of the Internet, routing of Internet connections was developed based on the use of the TCP/IP protocol stack (IP addresses, DNS names, URLs and URIs). Currently, like other companies, EMVCo, instead of its own networks, began to use the Internet as a transport network for interaction between participants in card payments, however, simultaneously with the use of the Internet, EMVCo continued to use BIN for routing connections between participants in making card payments.

Thus, one of the drawbacks of the existing routing of EMVCo card payments is the simultaneous use of two types of routing—BIN routing and Internet routing, which artificially complicates the payment system and hence reduces its reliability, limits the use of free addressing and routing of Internet connections and therefore increases the cost of payment services for users.

Donald E. Eastlake in 2001 proposed using the DNS names created in the special domain card.reg.int to replace BIN numbers. Donald Eastlake has written several RFCs for the IETF to consider, the most recent being “ISO 7812/7816 Numbers and the Domain Name System (DNS)” (http://tools.ietf.org/html/draft-eastlake-card-map-08). Essentially, Donald Eastlake proposed to replace the BIN number of the card 37012345678 with DNS with the name 3.2.1.0.7.3.z.card.reg.int. However, the developers of the ISO 7812/7816 standards have expressed concern that Donald Eastlake's initiative may contribute to a decrease in security due to the availability of card issuer identification numbers (BIN) on the Internet. In the eighth version of the Internet Draft, an example of a table is given, on the right side of which there are domain names of issuers, to which Internet calls are essentially redirected using DNS names located on the left side:

| | |
|---|---|
| * .brand.card.reg.int | unknown-brand.card.reg.int |
| * .1.brand.card.reg.int | www.air-travel-card.com |
| * .3.brand.card.reg.int | unknown-brand.card.reg.int |
| * .0.3.brand.card.reg.int | www.dinersclub.com |
| * .6.0.3.brand.card.reg.int | www.dinersclub.com |
| * .9.6.0.3.brand.card.reg.int | www.jcb.co.jp |
| * .8.0.3.brand.card.reg.int | www.dinersclub.com |

Another drawback of the solution proposed by Donald Eastlake is that in fact he proposed a redirect method, since the domain names in the card.reg.int domain are also associated with the domain names of the issuers, and not their IP addresses. At the same time, Serebrennikov's invention proposes to identify accounts using network names (for example, DNS names) and to match such names directly to the IP address of the payment gateway of the financial institution that serves the corresponding financial account. Resolving a DNS name directly to an IP address, and not to another DNS name, allows to halve the load on the DNS name resolution system, and also does not make card data available in the Internet DNS system.

Since Donald Eastlake's solution was proposed in 2001, and Serebrennikov's solution was proposed in 2003, that is, both solutions were proposed long before 2011, when the tokenization of EMVCo card payments was proposed, another drawback of Eastlake and Serebrennikov's solutions is that they do not suggest using network identifiers (e.g. DNS name) as the PAN token in the merchant table in line with EMVCo's guidelines for tokenizing payments.

The present invention eliminates the aforementioned disadvantages of the solution of Donald Eastlake and the invention of Serebrennikov, namely, the present invention offers:
1) place in the TSP table a user’ record containing the user’ accounts in various payment schemes (systems);
2) place in the named user record at least the user's PAN, as well as the Serebrennikov's routing identifier (hereinafter “DNS token”) as a PAN token, and account identifiers in other payment systems also as PAN tokens, in particular, place the wallet address for cryptocurrencies and other accounts;
3) use the named “DNS token” for routing connections to the TSP on the Internet, for which to match the “DNS token” with the IP address of the TSP in the database or registry of the DNS routing system for Internet connections;
4) provide the resolution service of the named “DNS token” to the named IP address of the Token Service Provider using the DNS routing system of Internet connections, thus ensuring the routing of connections to the TSP using the user's “DNS token”;
5) provide the service of resolving the “DNS token” to PAN and other account identifiers of various payment schemes (systems) using the named user record placed in the TSP’ table and containing the PAN and tokens mapped to it, represented by the user account identifiers in various payment schemes (systems).

Thus, the present invention contemplates placing in the Token Service Provider table the routing identifiers of at least two different routing systems, namely the BIN routing and the Internet routing network identifiers. At the same time, the present invention proposes to use Internet routing to establish connections with the Token Service Provider, for which the present invention proposes to resolve the named Internet network identifier into the network IP address of the Token Service Provider via the Internet DNS system. The technical result of creating a payment bridge and transition to the network level of addressing payments is achieved by the fact that for making a payment:
the user or acquirer, using the network identifier of the user's account, establishes an Internet connection with the TSP and transmits the named network identifier of the user's account to the TSP;
using the network identifier of user account, the TSP finds in the TSP table the user record containing the named network account identifier and corresponding identifiers of other user accounts, TSP then retrieves at least one of the found identifiers of other user accounts for making a payment either between user accounts in different payment schemes or between the user's account and the merchant's account.

Since the network identifier (primarily the DNS name, but can also be a URL or URI) is delegated directly to the account holder, this allows the named DNS identifier to be associated with the IP address of any TSP, in order to gain access to the PAN of the account holder located in the table of such TSP or to his other accounts located in the same table. Thus, the technical result of the present invention is the possibility of using a DNS token for addressing a TSP on the Internet using not application layer, as in EMVCo’ case, but a network payer for addressing payments, as well as the independence of the DNS token from the TSP and the portability of such a DNS token from one TSP to another. . . . Another technical result of the present invention is that access to the TSP account table using the named user network account identifier is a standard Internet method for routing connections for access, and therefore does not require special equipment and software by EMVCo, which is necessary in the case of using BIN identifiers.

At present the Token Service Providers routing table is intended for placing only PAN and a token for making EMVCo card payments, which does not allow using it for making payments between different payment schemes. However, there is a need to create a payment bridge between the PAN and, for example, crypto asset accounts, and this can be solved by placing the account identifier of the corresponding crypto asset account in the TSP table.

The modern development of payment systems is characterized by the fact that today exist simultaneously both traditional centralized payment systems, where the central bank is responsible for the security of payments, for making payments and for solving the problem of avoiding double spending, and decentralized payment systems, where the solution of these problems is ensured in a decentralized manner using the consensus mechanism. The most famous example of a decentralized payment system is the Bitcoin payment system. While centralized payment systems use the traditional account naming system, Bitcoin uses the hash of the account holder's public key, HASH (PUB), as the account address. Obviously, when using payment cards, it does not matter in what currency the card account is denominated and in what currency the purchase price is denominated, the payment system unnoticed by the account holder converts funds from one currency to another and the purchase will always be paid in the required currency. Since cryptocurrency can also be converted into fiat currencies, it would be logical to add the ability to convert the funds of the account identified by the PAN into cryptocurrency and vice versa. Differences between centralized and decentralized payment systems, namely differences in account identification, as well as in the methods of clearing and settlements between accounts, create difficulties for the seamless conversion of cryptocurrency to fiat money and vice versa when the account holder needs it, even if the account holder has accounts in both cryptocurrency and fiat money. Therefore, in order to make a payment between the cryptocurrency and fiat accounts of one user, he has to apply to exchange to convert from cryptocurrency to fiat money, which significantly complicates the use of cryptocurrency. Using the address of a cryptocurrency wallet as a token for a PAN allows you to map the PAN and the cryptocurrency account of one user within the Token Service Provider table and use the named accounts to make payments between them.

As shown above, the variety of account identification formats used and the lack of a unified payment routing system create difficulties in making payments between accounts of various centralized and decentralized payment systems (intersystem payments). At the same time, all payment systems are united by the fact that almost all of them use the Internet as a transport network for the exchange of payment instructions. Thus, the Internet connects payment systems, which allows one to match the network identifiers of Internet buyers (DNS names and others) to the network address of the TSP (IP address of the merchant) in the Internet DNS addressing system, which allows one to get network access to the TSP routing table using the user’ network identifier and DNS name resolution services, establish an Internet connection with the TSP and receive the service of searching the identifier of the user's accounts in various payment systems in the TSP using the named network identifier of the user. The use of appropriate technologies for making payments for each of the user's accounts located in the TSP table allows currency conversion between user accounts, whose identifiers are placed as PAN tokens in the TSP’ table.

Thus, the technical result of creating a payment bridge between various payment systems and the transition to the network level of addressing payments in accordance with the present invention is achieved by simultaneously placing in the TSP table, in addition to the PAN and BIN token, also a DNS token and possibly Crypto tokens, which are wallet addresses of various crypto assets, at least one crypto asset. A useful effect of the invention is that the DNS token of the user's account can be used to establish a connection with the merchant on the Internet, and the creation of a connection between the PAN account and the user's Crypto token in the merchant table allows for “seamless” operations of converting funds from the PAN account to the cryptocurrency account the user whose identifier is the Crypto token and back from the user's cryptocurrency account to the PAN account.

### Use Cases

Suppose the following account identifiers of Petr Petrov are placed in the Token Service Provider table:

| | | | HASH(PUB) |
|---|---|---|---|
| PAN | BIN token | DNS token | token |
| (card | (BIN token | (DNS/URL/URI) | BitCoin wallet |
| number) | PAN) | | address |

### EXAMPLE 1. Payment for Purchases Using PAN

Suppose, for payment for the shopping cart, the customer has chosen the “DNS payment” payment method according to Serebrennikov's method. After choosing the “DNS payment” method, the system prompts the buyer to enter the DNS identifier of the account (aka “DNS token”). In accordance with the present invention, after entering the DNS identifier of the customer's account, the said DNS identifier is resolved into the IP address of the Token Service Provider via the DNS system. The obtained IP address is used to establish an Internet connection with the Token Service Provider. After the Internet connection is established, the Token Service Provider is provided with the payment amount and the “DNS token” entered by the buyer earlier—it is the routing DNS identifier to the buyer's account in the Serebrennikov payment system. If the merchant's account is not known by default, then the Token Service Provider also receives the DNS identifier of the merchant's account or the Merchant ID of the merchant in the EMVCo card payment system. If the payment amount is nominated in fiat money, then using the received “DNS token” of the buyer's account, the Service Provider Token searches in the PAN table corresponding to the received “DNS token” and uses the PAN in accordance with the EMVCo regulations to transfer the said amount denominated in fiat currency to the seller (acquirer).

NOTE: The term “known by default” in relation to the merchant account ID means that the merchant account ID can be determined or found using a technique that does not require the transfer of the account ID itself.

For example, if a permanent network IP address is assigned to a merchant's terminal, then the named IP address, when establishing a connection with another Internet node, this IP address will become known to the named other node, which makes it possible to determine the merchant's account identifier using the table mapping merchants' permanent IP addresses to their account identifiers in payment system. To determine the default merchant account identifier, other techniques can be used that do not require the merchant identifier to be recorded in the payment instruction.

### EXAMPLE 2. Payment for Purchases Using Cryptocurrency

Let's also assume that in EXAMPLE 1, the payment amount is denominated in cryptocurrency. After the Internet connection is established with the Token Service Provider, the routing “DNS token” of the buyer and the HASH (PUB) BitCoin address of the seller's wallet are transferred to it. Using the obtained DNS identifier, the Service Provider Token finds in its table “HASH (PUB) token” corresponding to the received “DNS token” and uses the found “HASH (PUB) token” for invoicing in which it specifies as the payee the named HASH (PUB) address of the merchant's BitCoin wallet using one of the known methods, for example https://bitpay.com/ or https://coingate.com/accept-bitcoin or https://coinsbank.com/merchant or any other known method.

### EXAMPLE 3. Payment for the Purchase of Cryptocurrency

Suppose in EXAMPLE 1, a user buys cryptocurrency, with the purchase price expressed as an amount of fiat money. After establishing an Internet connection with the Token Service Provider, the value of the named amount of fiat money, the buyer's “DNS token”, and the seller's “HASH (PUB) token” or “DNS token” are transferred to it. Using the received “DNS token” of the buyer, the Token Service Provider finds in its table “HASH (PUB) token” corresponding to the received “DNS token” of the buyer and uses the found “HASH (PUB) token” of the buyer to issue an invoice to the seller in which he specifies as the payer named address “HASH (PUB) token” of the seller in one of the known ways, for example https://bitpay.com/ or https://coingate.com/accept-bitcoin or https://coinsbank.com/merchant or any other known way. At the same time, using the TSP by known merchant's HASH (PUB) token, the merchant's record is found in the table and the merchant's PAN or Merchant ID in it, and the buyer's PAN is found using the buyer's known DNS token, after which the TSP makes a payment from buyer's PAN to the PAN or Merchant ID of the seller.

The sale of cryptocurrency by a user can be carried out according to a scenario similar to EXAMPLE 3, which is not difficult to imagine for anyone who understands payment technologies.

### EXAMPLE 4. Paying for Purchases in Fiat From the User's Cryptocurrency Account

To pay from the user's cryptocurrency account for a purchase, the value of which is expressed in the amount of fiat money, it is necessary to 1) convert the amount of the buyer's cryptocurrency funds into the amount of fiat money and 2) pay for the purchase in fiat money received from the exchange of cryptocurrency for fiat money. To convert cryptocurrency into fiat money in accordance with EXAMPLE 1, a connection is established with the TSP and an instruction is sent to the TSP containing the user's “DNS token”, the amount of fiat money and an order to pay for the purchase from the user's cryptocurrency account. If the merchant's account is not known by default, then the Token Service Provider in the instruction is also given the “DNS token” of the merchant's account or the Merchant ID of the merchant in the EMVCo card payment system in order to find the merchant's record in the TSP. Having received the instruction, the TSP extracts the buyer's “DNS token” from the instruction and finds the buyer's record in the “PAN” TSP table and finds the buyer's “HASH (PUB) token” corresponding to the buyer's “DNS token” in the record. After that, using the exchange rate of cryptocurrency for fiat money, they calculate the amount of cryptocurrency equivalent to the amount of payment in fiat money, make the payment of the named amount of cryptocurrency from the buyer's “HASH (PUB) token” account to the cryptocurrency account of the broker or the currency exchange, and the corresponding amount of the broker's fiat money, or exchange credit to the buyer's PAN account with subsequent payment for the purchase from the buyer's PAN account, or the corresponding amount of fiat money from the broker or exchange account is credited directly to the merchant's account.

1. A method of making payments, in which to increase the security of card payments using a smartphone, instead of a payment card number (PAN), a token is placed on the smartphone in the Bank Identification Number format (BIN token), and the PAN and the corresponding BIN token are also placed in the Token Service Provider (TSP) database and in the buyer's smartphone, and when making a payment, instead of the PAN, the BIN token is read from the smartphone and used to route the connection to the TSP in the payment network, and after establishing a connection with the TSP, transferring the BIN token to the TSP, finding in the TSP’ database the PAN corresponding to BIN token, the named PAN is used for making a payment, characterized in that the customer is assigned with a customer identifier for Internet (DNS token), and the IP address of the TSP is mapped to the named customer identifier in the Internet routing system, then the named DNS token is written into the TSP database as the PAN token of the buyer, and when the payment is required the DNS token is entered and used to route and establish the Internet connection with the TSP, and after establishing the connection with the TSP, the named DNS token is transmitted to the TSP, the PAN corresponding to the DNS token is found in the TSP database, retrieved and used to conduct the payment.

2. The method according to claim 1, characterized in that the buyer is additionally assigned the address of the cryptocurrency wallet (ACW) and the said address is recorded as the ACW token for the buyer's PAN in the TSP database, the following types of payments are made available in the system: 1) payment with payment card accounts to a cryptocurrency wallet, 2) payment from a cryptocurrency wallet to a payment card account, 3) payment for a purchase from a payment card account 4) payment for a purchase from a cryptocurrency wallet; and each of the types is assigned with a payment type identifier, then when making a payment, the payment type identifier is additionally entered, and when searching in the TSP database, either the account pair identifiers of 1) PAN and ACW, or 2) PAN and ACW or the identifier of one accounts i) PAN, or ii) ACC, are retrieved and used to make a payment either between the pair of accounts whose identifiers have been retrieved, or make a payment for a purchase from one account whose identifier has been retrieved.
